(19) United States
(12) Patent Application Publication
(10) Pub. No.: US 2008/0070707 A1
(43) Pub. Date: Mar. 20, 2008

(54) ROTOR SHAFT AND MOTOR WITH ROTOR SHAFT

(75) Inventors: Toshio Yamamoto, Nagano (JP); Kiyoshi Nishimura, Nagano (JP); Yasushi Mizusaki, Nagano (JP); Takafumi Kuwazawa, Nagano (JP); Akitoshi Iizawa, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/830,384

(22) Filed: Jul. 30, 2007

(30) Foreign Application Priority Data
Jul. 28, 2006 (JP) 2006-206698
Jul. 28, 2006 (JP) 2006-206699
Apr. 23, 2007 (JP) 2007-112686
Jun. 21, 2007 (JP) 2007-163762

(51) Int. Cl. F16C 3/00; H02K 15/12

(52) U.S. Cl. 464/182; 310/45

(57) ABSTRACT

A rotor shaft may include a base shaft member for structuring the rotor shaft, a lead screw formed on an outer peripheral face of the base shaft member, and a resin film which covers the lead screw. Further, a motor may include a rotor shaft that is formed with a lead screw on a peripheral face of the rotor shaft, and a flank face of the lead screw is coated with a resin film. Also, a motor may include a rotor shaft and a bearing which rotatably supports the rotor shaft, at least a sliding portion of the rotor shaft on the bearing is covered with a resin film. The resin film is preferably an electrodeposited film and may contain solid lubricant, filler and fluid adjustment agent.

### CROSS REFERENCE TO RELATED APPLICATION

The present invention claims priority under 35 U.S.C. §119 to Japanese Application No. 2006-206698 filed Jul. 28, 2006, Japanese Application No. 2006-206699 filed Jul. 28, 2006, Japanese Application No. 2007-112686 filed Apr. 23, 2007, Japanese Application No. 2007-163762 filed Jun. 21, 2007, all of which are incorporated herein by reference.

### FIELD OF THE INVENTION

An embodiment of the present invention may relate to a rotor shaft in which a lead screw is formed on a peripheral face of its base shaft member and a motor provided with a rotor shaft.

### BACKGROUND OF THE INVENTION

For example, a stepping motor in which a lead screw is formed on an outer peripheral face of an output side portion of a rotor shaft is used as a motor which is used for a CD player or a DVD player. When the rotor shaft of the stepping motor is rotated, a rack part of a connection member engaged with a spiral groove of the lead screw and a carrier provided with the rack part are moved (see, for example, Japanese Patent Laid-Open No. 2006-144918).

Another motor has been known in which, for example, a permanent magnet is fitted to the rotor shaft to structure a rotor and a stator is disposed at a position facing the permanent magnet in a radial direction. The rotor shaft is rotatably supported by bearings (see, for example, Japanese Patent Laid-Open No. 2000-358350).

In the former patent reference, in a spiral groove forming process, barrel processing is performed on the rotor shaft by using a media for barrel having a size, which is capable of reaching to a flank face of the spiral groove of the rotor shaft, to form a number of minute recessed parts on the flank face. In this rotor shaft, grease is applied to the recessed parts to prevent occurrence of abrasion powder and blackening change of the lubricant and thus abrasion of the rack part can be prevented.

A rotor shaft as described in the latter patent reference has been conventionally made of stainless steel or brass. However, in recent years, downsizing and reducing weight have been required to the motor and thus, in order to cope with these requirements, it is conceivable that the rotor shaft is formed of aluminum or aluminum alloy. In other words, the specific gravity of stainless steel is 7.6-8.0, and the specific gravity of brass is 8.2-8.8. On the contrary, the specific gravity of aluminum or aluminum alloy is 2.6-2.8. Therefore, when the rotor shaft is formed of aluminum or aluminum alloy, weight of the rotor shaft is reduced. Further, in a case that the weight of the rotor shaft is reduced, when the same output is to be obtained, downsizing of a permanent magnet and a stator can be obtained and thus the weights of the permanent magnet and the stator can be reduced.

However, in the former patent reference, when the grease is not uniformly held in the recessed parts which are formed on the flank face, an extremely thin grease portion occurs and thus the flank face or the rack part may be worn at the portion where the grease is extremely thin.

Further, in the latter patent reference, when the rotor shaft is made of aluminum or aluminum alloy, its abrasion resistance and sliding property are not satisfactory. Therefore, even when grease is applied between a bearing and the rotor shaft or, when a bearing is made of resin, the rotor shaft is easily worn.

Further, in a case that the rotor shaft is made of iron or iron alloy, since its sliding property is not satisfactory, even when grease is applied between a bearing and the rotor shaft or, when a bearing is made of resin, the rotor shaft is also easily worn.

### SUMMARY OF THE INVENTION

In view of the problems described above, at least an embodiment of the present invention is directed to providing a rotor shaft which is capable of preventing wear and providing a motor in which the rotor shaft is used.

Further, in view of the problems described above, at least an embodiment of the present invention is directed to providing a motor which is capable of reducing a noise occurred at a sliding portion of a rotor shaft on a bearing. In addition, at least an embodiment of the present invention is directed to providing a motor which is capable of preventing wear at the sliding portion of the rotor shaft on the bearing even when the rotor shaft is structured by using material having low abrasion resistance and sliding property.

Thus, according to at least an embodiment of the present invention, there may be provided a rotor shaft including a base shaft member for structuring the rotor shaft, a lead screw which is formed on an outer peripheral face of the base shaft member, and a resin film which covers the lead screw. In this case, the resin film is preferably an electrodeposited film.

According to the embodiment described above, since the lead screw of the rotor shaft is covered with the resin film, wear of the lead screw due to sliding on an opposite sliding member is prevented. Further, since the lead screw is coated with the resin film, in a process for forming a spiral groove in the base shaft member of the rotor shaft, barrel processing or finishing process treatment for forming the flank face to be a smooth face can be omitted. In addition, when the resin film is an electrodeposited film, the resin film is easily formed with a uniform thickness on a complicated shape portion.

In accordance with an embodiment, a film thickness of the resin film at least on the flank face of the lead screw is 7 μm or more. In this case, it is preferable that the film thickness of the resin film is 10 μm or more. The film thickness of the resin film may be set in 20 μm or less and, even when the film thickness is set in 20 μm or more, an effect preventing occurrence of wear is saturated.

In accordance with an embodiment, the resin film is a polyimide system resin film. Further, the resin film may contain epoxy system resin having epoxy group as a thermal reactive group.

In accordance with an embodiment, the resin film contains solid lubricant. Polytetrafluoroethylene (PTFE) particles or graphite particles may be used as the solid lubricant and self lubrication and abrasion resistance of the solid lubricant itself can be improved.

In accordance with an embodiment, the resin film contains filler. Organic system filler may be used as the filler.

In accordance with an embodiment, the filler functions as a fluid adjustment agent for improving flowability of resin. Acrylic-melamine system resin may be used as the fluid adjustment agent. According to this embodiment, the filler acts as a fluid adjustment agent and flowability of the resin is improved. Acrylic-melamine system resin is contained in the electrodeposited film as coating colloid at the time of anion electrodeposition to suppress flowability at the time of thermal curing and thus a film with a high degree of uniformity is formed. Further, the edge cover rate is also improved.

In accordance with an embodiment, the base shaft member is made of aluminum or aluminum alloy. When the base shaft member of the rotor shaft is made of aluminum or aluminum alloy, the weight of the rotor shaft can be reduced. Therefore, when the rotor shaft in accordance with this embodiment is used in a motor, the weight of the motor can be reduced. Further, when the weight of the rotor shaft is reduced, in a case that the same output is to be obtained, the sizes of the permanent magnet and the stator can be reduced and thus the size of the motor is reduced. In addition, the weight of the motor can be also reduced by the downsizing amount of the permanent magnet and the stator.

In accordance with an embodiment, an alumite film is formed between the base shaft member and the resin film. Since the alumite film is hard, the hardness of the rotor shaft is improved by forming the alumite film. Further, since the alumite film functions as a protecting film, corrosion resistance of the rotor shaft is improved.

In accordance with an embodiment, the base shaft member is made of iron or iron alloy. When the base shaft member of the rotor shaft is made of iron or iron alloy, the rotor shaft can be produced at a low cost.

In accordance with an embodiment, the base shaft member is made of iron material (iron or iron alloy) and a chemical conversion film is preferably formed between the base shaft member and the resin film. For example, a phosphate film such as tribasic zinc phosphate film, manganese phosphate film, iron phosphate film is formed as the chemical conversion film and, in this case, the phosphate film is formed in a porous structure and thus adhesive strength between the resin film and the base shaft member is improved by anchoring effect. Further, when the chemical conversion film is formed with a high degree of corrosion resistance, the film can be functioned as a protecting film.

Further, according to at least an embodiment of the present invention, there may be provided a motor including a rotor shaft, a rotor which is provided with the rotor shaft, and a bearing which rotatably supports the rotor shaft. In this motor, at least a sliding portion of the rotor shaft on the bearing is covered with a resin film.

In accordance with this embodiment, since the sliding portion of the rotor shaft on the bearing is covered with a resin film, occurrence of a noise can be restrained. Further, since the sliding portion of the rotor shaft on the bearing is coated with the resin film, a finishing process for forming the sliding portion of the rotor shaft to be a smooth face can be omitted. In addition, when the resin film is formed with an electrodeposited film, the film is easily formed with a uniform thickness at a portion in a complicated shape in comparison with a method of coating the resin. Further, even when material whose abrasion resistance and sliding property are not satisfactory such as aluminum or aluminum alloy is used for the rotor shaft, wear of the sliding portion of the rotor shaft on the bearing can be prevented.

In accordance with an embodiment, the resin film is an electrodeposited film. A polyimide system resin film and an epoxy system resin having epoxy group as a thermal reactive group may be used as the resin film.

In accordance with an embodiment, the resin film contains solid lubricant. Polytetrafluoroethylene (PTFE) particles and graphite particles may be used as the solid lubricant. In this case, self lubrication and abrasion resistance of the solid lubricant itself can be improved.

Further, it is preferable that the resin film contains filler and it is preferable that the filler functions as a fluid adjustment agent for improving flowability of resin. Acrylic-melamine system resin may be used as the fluid adjustment agent. According to this embodiment, the filler acts as a fluid adjustment agent and flowability of resin is improved. Acrylic-melamine system resin is contained in the electrodeposited film as coating colloid at the time of anion electrodeposition to suppress flowability at the time of thermal curing and thus a film with a high degree of uniformity is formed. Further, the edge cover rate can be also improved. In accordance with an embodiment, organic system filler may be used as the filler.

In accordance with an embodiment, the base shaft member of the rotor shaft is made of aluminum or aluminum alloy. When the base shaft member of the rotor shaft is made of aluminum or aluminum alloy, the weight of the rotor shaft can be reduced and thus the weight of the motor can be reduced. Further, when the weight of the rotor shaft is reduced, in a case that the same output is to be obtained, the sizes of the permanent magnet and the stator are reduced and thus the size of the motor can be reduced. In addition, the weight of the motor can be also reduced by the downsizing amount of the permanent magnet and the stator.

In accordance with an embodiment, an alumite film is formed between the base shaft member of the rotor shaft and the resin film. Since the alumite film is hard, the hardness of the rotor shaft is improved by forming the alumite film and corrosion resistance of the rotor shaft is improved.

In accordance with an embodiment, the base shaft member is made of iron or iron alloy. In this case, a chemical conversion film is preferably formed between the base shaft member and the resin film. For example, a phosphate film such as tribasic zinc phosphate film, manganese phosphate film, iron phosphate film is formed as the chemical conversion film and, in this case, the phosphate film is formed in a porous structure and thus adhesive strength between the resin film and the base shaft member is improved by anchoring effect. Further, when a chemical conversion film with a high degree of corrosion resistance is formed, the film can be functioned as a protecting film.

In accordance with an embodiment, the rotor shaft is formed with a spherical part which is supported by the bearing. According to the structure as described above, different from a case that a ball is interposed between the rotor shaft and the bearing and thus there is a problem that the position of the ball is shifted due to a dimensional tolerance of the film thickness of the resin film, a stable characteristic of the bearing can be obtained.

In accordance with an embodiment, a lead screw is formed on an outer peripheral face of the base shaft member of the rotor shaft and the lead screw is covered with the resin film. In the case that a lead screw is formed on the rotor shaft, a carrier is engaged with the lead screw to be moved along the lead screw through rotation of the lead screw. Therefore, slide movement is occurred between the lead screw and the carrier. According to this embodiment, the sliding portion of the lead screw on the carrier is coated with the resin film. Therefore, even when material such as aluminum or aluminum alloy whose abrasion resistance and sliding property are not satisfactory is used for the rotor shaft, wear of the sliding portion on the carrier can be prevented. Further, since the sliding portion of the lead screw on the carrier is coated with the resin film, a finishing process treatment for forming the sliding portion of the lead screw to be a smooth face can be omitted in the base shaft member of the rotor shaft.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(a) is a half cross sectional view showing a stepping motor in accordance with an embodiment of the present invention, FIG. 1(b) is a rear view showing the stepping motor which is viewed from an opposite-to-output side and FIG. 1(c) is an explanatory view showing a rotor shaft.

FIG. 2(a) is an explanatory view showing a lead screw formed on a rotor shaft of a stepping motor in accordance with an embodiment of the present invention and FIG. 2(b) is an enlarged cross-sectional view showing the lead screw.

FIG. 3(a) is an explanatory view showing an output side bearing and FIG. 3(b) is an explanatory view showing an opposite-to-output side bearing of the stepping motor shown in FIG. 1(a).

FIG. 4(a) is an explanatory sectional view schematically showing a shape of a resin film which is formed on a rotor shaft of a stepping motor in accordance with an embodiment of the present invention. FIG. 4(b) is an explanatory sectional view schematically showing a shape of a resin film in a comparison example. FIG. 4(c) is an explanatory sectional view schematically showing a shape of a resin film which is formed on a lead screw of a rotor shaft in accordance with an embodiment of the present invention.

FIGS. 5(a) and 5(b) are explanatory views showing another bearing structures which are used in a motor in accordance with an embodiment of the present invention.

### DETAILED DESCRIPTION OF THE PREFERRED EMBODIMENTS

A motor to which the present invention is applied will be described below with reference to the accompanying drawings.

### First Embodiment

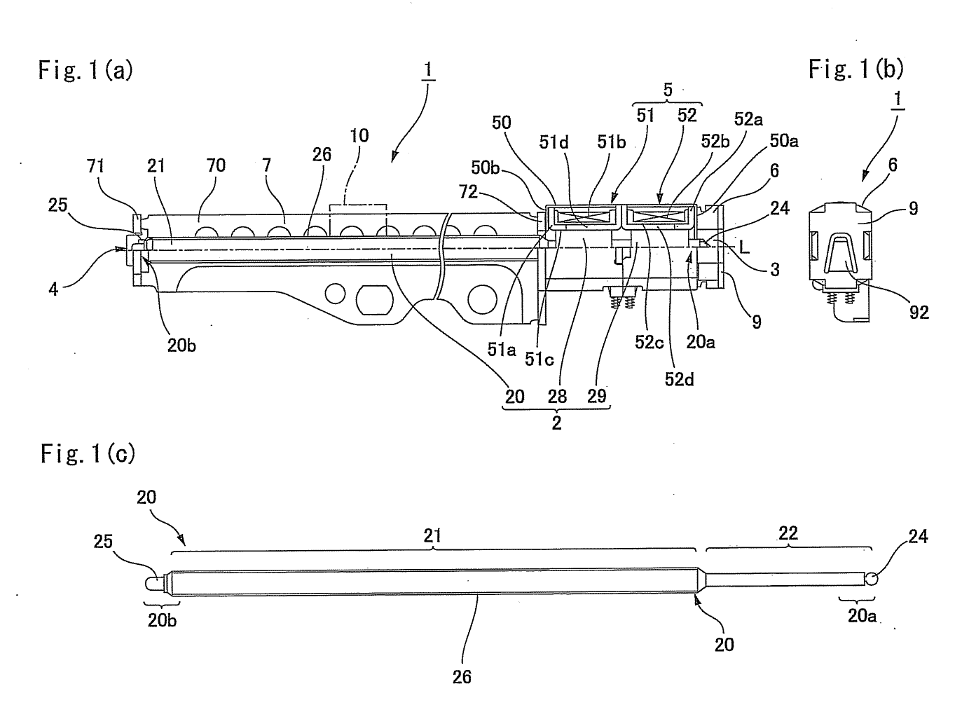

FIG. 1(a) is a half cross sectional view showing a stepping motor in accordance with an embodiment of the present invention, FIG. 1(b) is a rear view showing the stepping motor which is viewed from an opposite-to-output side and FIG. 1(c) is an explanatory view showing a rotor shaft.

In FIGS. 1(a) and 1(b), a stepping motor 1 in accordance with a first embodiment of the present invention includes a stator 5, a rotor 2, a motor case 50 which covers the stator 5, and a frame 7 which is fixed to an output side of the stator 5. The rotor 2 includes a rotor shaft 20 and two permanent magnets 28 and 29 which are fixed to a portion on an opposite-to-output side of the rotor shaft 20 at adjacent positions in an axial direction. Each of the permanent magnets 28 and 29 is magnetized so that an N-pole and an S-pole are alternately disposed in a circumferential direction. The stator 5 is provided with two stator assemblies 51 and 52 which are disposed so as to be superposed in the axial direction at positions where they face the permanent magnets 28 and 29 on their outer peripheral side. The stator assemblies 51 and 52 respectively include outer stator cores 51a and 52a, bobbins 51c and 52c around which coils 51b and 52b are wound, and inner stator cores 51d and 52d which sandwich the bobbins 51c and 52c between the outer stator cores and the inner stator cores 51d and 52d. The outer stator cores 51a and 52a and the inner stator cores 51d and 52d are respectively provided with a plurality of pole teeth which are disposed at an inner peripheral portion of the stator 5.

As shown in FIGS. 1(a) and 1(c), the rotor shaft 20 is provided with a small diameter shaft part 22 and a large diameter shaft part 21. The permanent magnets 28 and 29 are fixed to the small diameter shaft part 22. A rear end part of the small diameter shaft part 22 of the rotor shaft 20 structures an opposite-to-output side shaft end 20a which protrudes on an opposite-to-output side from the motor case 50. The large diameter shaft part 21 protrudes from an output side end plate 50b of the motor case 50 and a lead screw 26 is formed on its outer peripheral face.

A frame 7 includes a fixing plate part 72 which is fixed to the output side end plate 50b of the motor case 50, an opposite plate part 71 which is formed on the output side so as to face the fixing plate part 72, and a connecting plate part 70 which connects the fixing plate part 72 with the this opposite plate part 71.

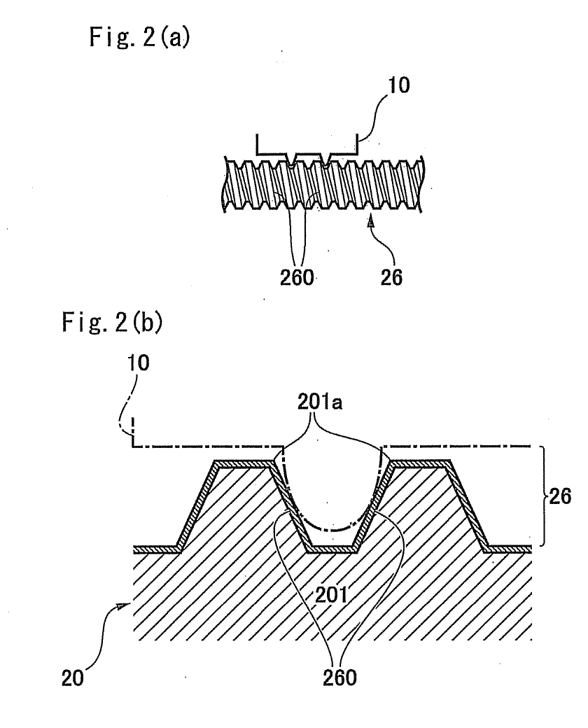

FIG. 2(a) is an explanatory view showing a lead screw formed on a rotor shaft of a stepping motor in accordance with an embodiment of the present invention and FIG. 2(b) is an enlarged cross-sectional view showing the lead screw.

As shown in FIGS. 2(a) and 2(b), a carrier 10 is engaged with the lead screw 26 and the carrier 10 is provided with a mechanism (not shown) which prevents co-rotation with the lead screw 26. Therefore, when the rotor shaft 20 is rotated, the carrier 10 moves in the axial direction of the rotor shaft 20 along the lead screw 26 and the carrier 10 slides on a flank face 260 of the lead screw 26. In this case, lubricant such as grease may be applied on the flank face 260 of the lead screw 26 if necessary.

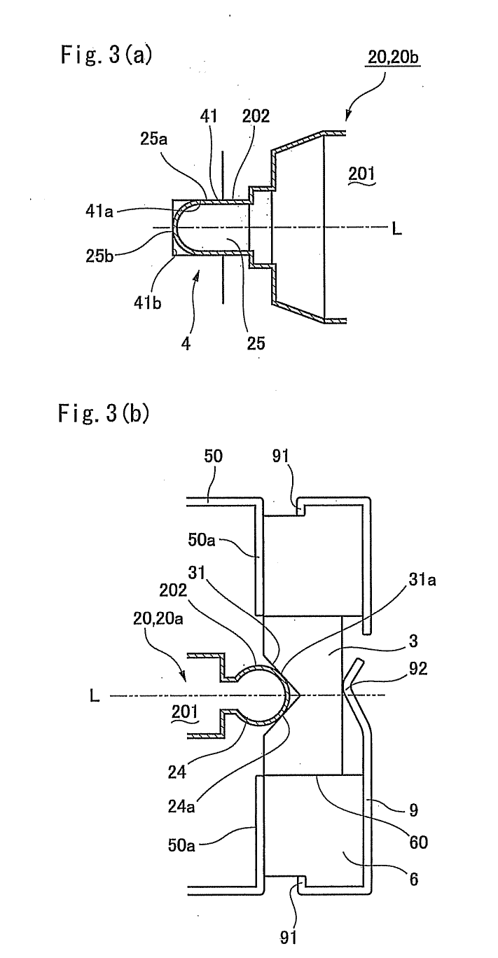

FIG. 3(a) is an explanatory view showing an output side bearing and FIG. 3(b) is an explanatory view showing an opposite-to-output side bearing of the stepping motor shown in FIG. 1(a).

In FIG. 1(a), the stepping motor 1 in the first embodiment includes an opposite-to-output side bearing 3, a bearing holder 6 and an urging member 9, which are disposed on the opposite-to-output side of the rotor shaft 20, and an output side bearing 4 which is disposed on an output side of the rotor shaft 20. Therefore, the opposite-to-output side shaft end 20a of the rotor shaft 20 is supported by the opposite-to-output side bearing 3 which is fitted to the bearing holder 6, and an output side shaft end 20b of the rotor shaft 20 is supported by the output side bearing 4 which is held by the opposite plate part 71 of the frame 7. The opposite-to-output side bearing 3 and the output side bearing 4 may be made of metal or resin but, in the first embodiment, they are formed of polybutylene terephthalate.

As shown in FIG. 3(a), the output side shaft end 20b of the rotor shaft 20 is formed with a round bar-shaped protruded part 25 having a small diameter which is provided with an outer peripheral face that is parallel to an axial line “L” of the rotor shaft 20. The output side bearing 4 is structured as a first bearing which supports an outer peripheral part 25a of the round bar-shaped protruded part 25 with an inner peripheral side face 41a of a circular recessed part 41 in a radial direction. The inner peripheral side face 41a of the circular recessed part 41 is formed to be parallel to the axial line “L” of the rotor shaft 20. An end face 25b of the round bar-shaped protruded part 25 is formed to be a spherical face and the end face 25b (spherical face) is supported by a bottom part 41b of the circular recessed part 41 of the output side bearing 4 in a thrust direction. Lubricant such as grease may be applied in the inside of the circular recessed part 41 if necessary.

As shown in FIG. 3(b), a spherical protruded part 24 is formed in the opposite-to-output side shaft end 20a of the rotor shaft 20 and the opposite-to-output side bearing 3 is structured as a second bearing which supports a portion 24a near the axial line “L” of the spherical protruded part 24 with a conical face 31a of a conical recessed part 31 in a radial direction and a thrust direction. Lubricant such as grease may be applied in the inside of the conical recessed part 31 if necessary.

The bearing holder 6 is fixed to the opposite-to-output side end plate 50a of the motor case 50 and a through hole 60 into which the opposite-to-output side bearing 3 is fitted is formed in the bearing holder 6. Further, the urging member 9 made of a metal plate is further disposed on the opposite-to-output side of the bearing holder 6. A plurality of pawl parts 91 is formed from an outer peripheral edge of the urging member 9 so as to extend to the opposite face side to engage with the bearing holder 6 and thus the urging member 9 is fixed to the bearing holder 6. A flat spring part 92 is formed in the urging member 9 by cutting and being bent, and the flat spring part 92 urges the opposite-to-output side bearing 3 to an output side. Therefore, the rotor shaft 20 is urged to the output side bearing 4 to prevent the rotor shaft 20 from shaking.

In the stepping motor 1 which is structured as described above, a base shaft member 201 of the rotor shaft 20 is made of aluminum or aluminum alloy. Further, in order to solve a problem that abrasion resistance and sliding property of aluminum or aluminum alloy, which is used as the base shaft member 201 of the rotor shaft 20, are not satisfactory, the following structure is adopted in this embodiment.

First, in this embodiment, as shown in FIG. 2(b) and FIGS. 3(a) and 3(b), a resin film 202 which is an electrodeposited resin film is formed on a roughly entire face of the rotor shaft 20.

Therefore, as shown in FIG. 2(b), the lead screw 26 is covered with the resin film 202 which is the electrodeposited film and thus the flank face 260 (sliding portion on the carrier 10) of the lead screw 26 which slides on the carrier 10 is covered with the resin film 202 which is an electrodeposited resin film. Further, as shown in FIG. 3(a), in the output side shaft end 20b of the rotor shaft 20, a surface (sliding portion on the bearing 4) of the round bar-shaped protruded part 25 which slides on the output side bearing 4 is covered with the resin film 202 which is an electrodeposited resin film. Further, as shown in FIG. 3(b), in the opposite-to-output side shaft end 20a of the rotor shaft 20, a surface (sliding portion on the bearing 3) of the spherical protruded part 24 which slides on the opposite-to-output side bearing 3 is also covered with the resin film 202 which is an electrodeposited resin film.

In this embodiment, a polyimide system resin film is used as the resin film 202. Further, the resin film 202 contains polytetrafluoroethylene (PTFE) particles and graphite particles as solid lubricant, which is provided with self-lubrication and abrasion resistance. Solid lubricant may be used which is provided with stratified molecular structure having a comparatively longer interlayer distance. Specifically, molybdenum disulfide and tungsten disulfide may be used as the solid lubricant other than polytetrafluoroethylene and graphite.

In order to manufacture the rotor shaft 20 of the stepping motor 1 which is structured as described above, firstly, a base shaft member 201 of the rotor shaft 20 is previously prepared by a method such as cutting work or form rolling, which is provided with the lead screw 26, the output side shaft end 20b, the round bar-shaped protruded part 25, the spherical protruded part 24 and the like of the rotor shaft 20 that are described with reference to FIGS. 1(a) through 3(b). After that, the base shaft member 201 is performed with finishing processing to improve its surface roughness and then an electrodeposition process which will be described below is performed.

In order to perform an electrodeposition process, electrodeposition coating material is prepared in advance. In this embodiment, heat resistant resin material which is a base of electrodeposition coating material is polyimide. The polyimide is synthesized such that acid component of polyimide system material (for example, bicycloocto-7-en-2,3,5,6-tetracarboxylic dianhydride) is dissolved in a solvent (for example, N-methylpyrrolidone), its solution is stirred for several hours, and obtained solution is put into a dialytic tube to remove miscellaneous ions in the organic solvent and the like. The dialysis described above is performed till the solution becomes substantially neutral. The polyimide which is synthesized in this embodiment is cation system which itself is charged in positive. However, the present invention is not limited to the cation system and anionic system which itself is charged in negative may be used.

Next, polytetrafluoroethylene particles of 5-40 wt. % (from 5 wt. % to 40 wt. %) in a weight ratio of solid content of polyimide are added as the solid lubricant to the polyimide of 10-20 wt. % (from 10 wt. % to 20 wt. %) which is obtained through the above-mentioned process. In this embodiment, the polytetrafluoroethylene particles of 10-30 wt. % (especially, 20±5 wt. %) are preferably added in the weight ratio of solid content of polyimide. As a result, the solution can be prevented from turning to gel (semisolid) state or prevented from occurring precipitation and management of the liquid becomes easy. Further, in this embodiment, graphite particles of, for example, 3-15 wt. % in the weight ratio of solid content of polyimide are added to the liquid which is blended with the polytetrafluoroethylene particles. With regard to the blended amount of the graphite particles, the graphite particles of 3-5 wt. % in the weight ratio of solid content of polyimide are preferably added in consideration of being blended along with the polytetrafluoroethylene particles. When the content of polyimide as heat resistant resin material is less than 10 wt. %, it is not preferable because the polytetrafluoroethylene particles as solid lubricant becomes to be easily precipitated during electrodeposition. On the contrary, when the content of the polyimide is more than 20 wt. %, it is not preferable because its surface energy becomes low and defective coating appearance such as repellence may occur easily. When the content of the polytetrafluoroethylene particles are less than 10 wt. %, it is not preferable because its lubricating ability is not sufficient. On the contrary, when the content of the polytetrafluoroethylene particles is more than 30 wt. %, it is not preferable because the polytetrafluoroethylene particles or the graphite particles are not uniformly dispersed to be easily precipitated. When the content of the graphite particles is less than 3 wt. %, it is not preferable because its effect is not sufficient and, on the contrary, when the content is more than 5 wt. %, precipitation may be easily occurred. In accordance with an embodiment, in order to render the electrodeposition coating material obtained through the above-mentioned process to be water-soluble, ion-exchange water, weak acid such as lactic acid or acetic acid, or solvent such as isopropyl alcohol or butylcellosolve may be added.

The electrodeposition coating material obtained as described above is mixed with pure water to prepare electrodeposition liquid. On the other hand, degreasing process and cleaning process are performed on the base shaft member 201 of the rotor shaft 20. For example, after ultrasonic cleaning is performed for one minute by using isopropyl alcohol, pure water cleansing is performed.

Next, since the electrodeposition liquid is, in this embodiment, a cation type electrodeposition liquid, the base shaft member 201 of the rotor shaft 20 is dipped in the electrodeposition liquid and a DC voltage is applied by using the base shaft member 201 as a negative electrode and an electrolytic cell, which is a counter electrode, as a positive electrode. When the electrodeposition is to be performed, power is supplied to a portion of the base shaft member 201 except the round bar-shaped protruded part 25 (sliding portion on the bearing 4), the spherical protruded part 24 (sliding portion on the bearing 3), and the flank face 260 of the lead screw 26 (sliding portion on the carrier 10). In this case, temperature of the electrodeposition liquid is set, for example, at 25° C. (degrees Celsius). Further, an applied voltage is set at 50-200V (from 50 volts to 200 volts) and electrodeposition is performed under a constant voltage for about two minutes to obtain an electrodeposited film with a thickness of 3-50 μm (from 3 μm to 50 μm). It is preferable that a film thickness of at least the flank face 260 is 7 μm or more, for example, 10 μm or more. As a result, the electrodeposited film is formed on the surface of the base shaft member 201 of the rotor shaft 20. Further, electrodeposition is similarly performed on the edge part 201a of the lead screw 26 under the same condition as described above to obtain the electrodeposited film with a film thickness of 7 μm or more.

Next, water washing, pure water washing, dewatering and the like are performed. After that, preheating is performed under a condition with a temperature of 110° C. (degrees Celsius) for 15 minutes and then heating is performed under a condition with a temperature of 230° C. (degrees Celsius) for 40 minutes to cure the resin component in the electrodeposited film. As a result, the rotor shaft 20 is manufactured in which the resin film 202 which is the electrodeposited film is formed on the surface of the base shaft member 201 that is made of aluminum or aluminum alloy. Further, the resin film 202 contains polytetrafluoroethylene particles and graphite particles as the solid lubricant in the base material made of polyimide system resin.

As described above, in the stepping motor 1 in this embodiment, the base shaft member 201 of the rotor shaft 20 is made of aluminum or aluminum alloy. Therefore, the weight of the rotor shaft 20 can be reduced in comparison with a case that the rotor shaft 20 is made of stainless steel or brass and thus the weight of the stepping motor 1 can be reduced. Further, when the weight of the rotor shaft 20 is reduced, in a case that the same output is to be obtained, downsizing of the permanent magnets 28 and 29 and the stator 5 can be obtained and thus the size of the stepping motor 1 can be reduced. In addition, the weight of the stepping motor 1 can be also reduced by the downsizing amount of the permanent magnets 28 and 29 and the stator 5.

Further, in this embodiment, the lead screw 26 of the rotor shaft 20 is coated with the resin film 202. Therefore, even when material such as aluminum or aluminum alloy whose abrasion resistance and sliding property are not satisfactory is used for the rotor shaft 20, wear of the sliding portion (flank face 260) on the carrier 10 can be prevented. Accordingly, in the feeding operation of the carrier 10, malfunction due to wear of the rotor shaft 20 can be prevented. Further, even when grease is coated on the lead screw 26, blackening change of the grease due to wear powder can be prevented.

Further, since the sliding portion (flank face 260) of the lead screw 26 on the carrier 10 is covered with the resin film 202, the contact face of the sliding portion with the carrier 10 becomes a smooth face. Therefore, wear of the carrier 10 is prevented and stable engagement of the carrier 10 with the lead screw 26 can be obtained. As a result, stable operation can be attained.

Further, in this embodiment, the sliding portions with the bearings (the round bar-shaped protruded part 25 and the spherical protruded part 24) are also covered with the resin film 202. Therefore, even when material such as aluminum or aluminum alloy whose abrasion resistance and sliding property are not satisfactory is used for the rotor shaft 20, wear of the sliding portion of the rotor shaft 20 on the bearing can be prevented. Accordingly, malfunction in the bearing portion due to wear of the rotor shaft 20 can be prevented. Further, even when grease is coated on the sliding portion of the rotor shaft 20 on the bearing, blackening change of the grease due to wear powder can be prevented.

Further, when the weight of the rotor 2 is reduced, its starting property to pulse frequency is improved and, in addition, its sliding property is improved by the resin film 202 and thus the starting property and responsibility are furthermore improved.

In addition, since the resin film 202 is formed of an electrodeposited film, the resin film 202 with a uniform thickness is easily formed on a portion in a complicated shape in comparison with a resin film which is formed by a method such as dip coating. Further, when the resin film 202 is formed of the electrodeposited film, the resin film 202 can be firmly and uniformly formed at a short time in comparison with the film formed by a method of dip coating and its quality can be easily maintained.

In addition, the sliding portion (the round bar-shaped protruded part 25 and the spherical protruded part 24) of the rotor shaft 20 on the bearing and the sliding portion (flank face 260) of the lead screw 26 on the carrier 10 are covered with the resin film 202. Therefore, a finishing process for forming these sliding portions of the base shaft member 201 of the rotor shaft 20 to be in a smooth face can be omitted. Further, corrosion resistance of the base shaft member 201 is also improved by the resin film 202.

Further, since the base material of the resin film 202 is a polyimide system resin, its heat resistance and abrasion resistance can be improved.

### Second Embodiment

A basic structure of a second embodiment of the present invention is similar to that of the first embodiment and thus the second embodiment will be similarly described with reference to FIGS. 1(a) through 3(b) and the description of the common portions is omitted. In FIGS. 1(a) through 3(b), in the stepping motor 1 of the second embodiment, similarly to the first embodiment, the base shaft member 201 of the rotor shaft 20 is made of aluminum or aluminum alloy. Further, in the second embodiment, similarly to the first embodiment, as shown in FIG. 2(b) and FIGS. 3(a) and 3(b), a resin film 202 which is an electrodeposited film is formed on a roughly entire face of the rotor shaft 20. Therefore, as shown in FIG. 2(b), the lead screw 26 is covered with the resin film 202 which is the electrodeposited film and thus the flank face 260 (sliding portion on the carrier 10) of the lead screw 26 which slides on the carrier 10 is covered with the resin film 202 which is an electrodeposited resin film. Further, as shown in FIG. 3(a), in the output side shaft end 20b of the rotor shaft 20, a surface (sliding portion on bearing) of the round bar-shaped protruded part 25 which slides on the output side bearing 4 is covered with the resin film 202 which is an electrodeposited resin film. In addition, as shown in FIG. 3(b), in the opposite-to-output side shaft end 20a of the rotor shaft 20, a surface (sliding portion on bearing) of the spherical protruded part 24 which slides on the opposite-to-output side bearing 3 is also covered with the resin film 202 which is an electrodeposited resin film.

In this embodiment, an epoxy system resin film which includes an epoxy group as a thermal reaction group is used as the resin film 202. The epoxy system resin film is an electrodeposited film formed by anion electrodeposition and is formed of a thermosetting resin with the use of, for example, epoxy-acrylic system resin (base resin) and melamine (curing agent). The epoxy-acrylic system resin is a mixed resin of epoxy resin with acrylic resin. However, an epoxy modified acrylic resin or the like may be used for the epoxy system resin film. Further, the resin film 202 contains the following filler.

In this embodiment, the resin film 202 contains an acrylic-melamine system resin as a filler. The filler acts as a fluid adjustment agent to improve flowability of the resin film 202. In this embodiment, the acrylic-melamine system resin is contained in the electrodeposited film as a coating colloid when anion electrodeposition is performed. As a result, flowability is suppressed at the time of heat curing and the film with a high degree of uniformity can be formed in the flank face 260. In addition, the edge coverability can be also improved. Polymer beads in a powder shape made of polyethylene, polypropylene, polyethyl methacrylate or the like may be used as the fluid adjustment agent (filler) other than the particles of acrylic-melamine system resin.

The resin film 202 contains particles of titanium oxide (TiO₂) as the filler. The filler acts as an extender pigment and is used for reinforcement and increasing in quantity of the resin film 202. Further, titanium oxide is also used as the fluid adjustment auxiliary agent which suppresses flowability of the electrodeposited film at the time of heat curing to form a film with a high degree of uniformity on the flank face 260. In addition, titanium oxide is also used as the fluid adjustment auxiliary agent which improves the edge cover rate. Clay mineral such as talc, mica and sericite, barium sulfate and the like may be used as the filler (extender pigment and fluid adjustment auxiliary agent) other than titanium oxide.

The resin film 202 contains carbon black as a filler. The filler functions as a coloring agent.

The resin film 202 may contain, similarly to the first embodiment, the solid lubricant such as polytetrafluoroethylene (PTFE) particles, graphite particles, molybdenum disulfide, tungsten disulfide.

In order to manufacture the rotor shaft 20 of the stepping motor 1 which is structured as described above, firstly, a base shaft member 201 of the rotor shaft 20 is previously prepared by a method such as cutting work or form rolling. The base shaft member 201 is provided with the lead screw 26, the output side shaft end 20b, the round bar-shaped protruded part 25, the spherical protruded part 24 and the like which are described with reference to FIGS. 1(a) through 3(b). After that, the base shaft member 201 is performed with finishing processing to improve its surface roughness and then an electrodeposition step which will be described below is performed.

In order to perform electrodeposition process, anionic system electrodeposition liquid having, for example, the following composition is prepared as electrodeposition coating material;
Epoxy system resin (binder)
   Epoxy-acrylic system resin (base resin)+melamine (curing agent): 7.5%
Melamine system resin (fluid adjustment agent)
   Acrylic-melamine system resin (base resin)+melamine (curing agent): 2.5%
Titanium oxide (extender pigment/fluid adjustment auxiliary agent): 2% (20 ml/l)
Carbon black (color pigment): 1% (10 ml/l)
Balance: 90% water+10% organic solvent.
   In this state, the epoxy-acrylic system resin (base resin) reacts with the melamine (curing agent) to form coating colloid whose size is several hundred nm, which is dispersed in the electrodeposition liquid. The acrylic-melamine system resin (base resin) reacts with melamine (curing agent) to form microgel particles whose size is several μms, which are dispersed in the electrodeposition liquid. The titanium oxide is dispersed in the electrodeposition liquid as particles whose size is several hundred nms. The carbon black (color pigment) is also dispersed in the electrodeposition liquid.

Degreasing process with a weakly alkaline degreasing agent and cleaning process are performed on the base shaft member 201 of the rotor shaft 20.

Next, the base shaft member 201 of the rotor shaft 20 is dipped in the electrodeposition liquid and a DC voltage is applied by using the base shaft member 201 as a positive electrode and an electrolytic cell, which is a counter electrode, as a negative electrode. In order to perform the electrodeposition as described above, power is supplied to a portion of the base shaft member 201 except the round bar-shaped protruded part 25 (sliding portion on the bearing 4), the spherical protruded part 24 (sliding portion on the bearing 3), and the flank face 260 of the lead screw 26 (sliding portion on the carrier 10). Further, an applied voltage is set at 50-200V and electrodeposition is performed under a constant voltage for about two minutes to obtain an electrodeposited film with a thickness of 3-50 μm. It is preferable that a film thickness of at least the flank face 260 is 7 μm or more, for example, 10 μm. As a result, the electrodeposited film is formed on the surface of the base shaft member 201 of the rotor shaft 20. In this state, particles of acrylic-melamine system resin (fluid adjustment agent) having a large particle diameter and particles of titanium oxide (fluid adjustment auxiliary agent) are held in the electrodeposited film of the epoxy system resin in addition to the carbon black.

Next, water washing, pure water washing, dewatering and the like are performed. After that, preheating is performed under a condition with a temperature of 100° C. (degrees Celsius) for 15 minutes and then heating is performed under a condition with a temperature of 180° C. (degrees Celsius) for 30 minutes to cure the resin component in the electrodeposited film. As a result, the epoxy system resin is cured while flowing to form a layer and the acrylic-melamine system resin is also melted. In this case, the acrylic-melamine system resin and the titanium oxide suppress excessive flowing of the epoxy system resin to prevent from dripping or the like. In this manner, the rotor shaft 20 is manufactured in which the resin film 202 which is the electrodeposited film is formed on the surface of the base shaft member 201 made of aluminum or aluminum alloy. Further, the resin film 202 contains the fluid adjustment agent (acrylic-melamine system resin), titanium oxide (fluid adjustment auxiliary agent/extender pigment) and carbon black (color pigment) as the filler in the epoxy resin film.

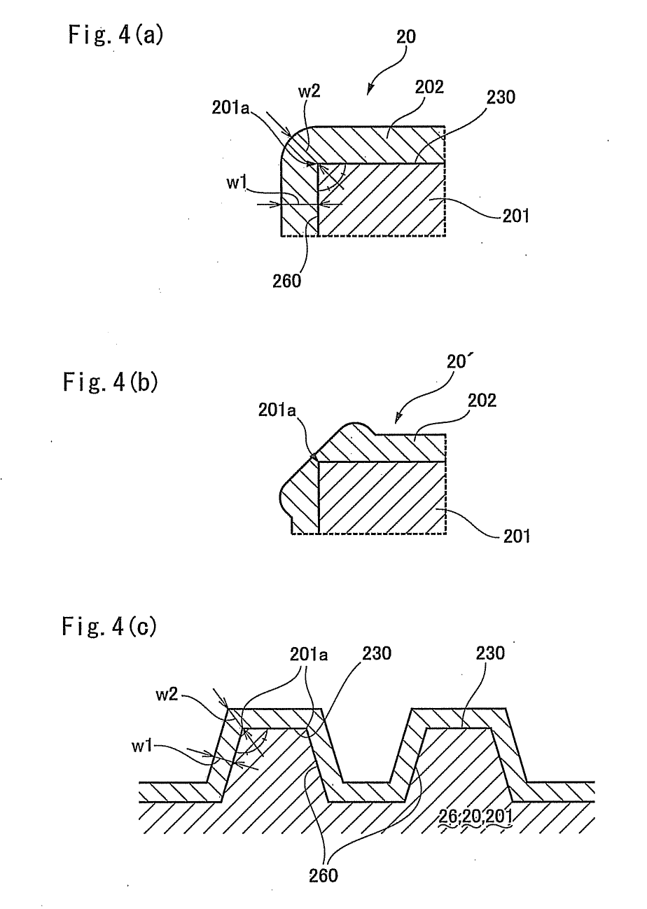

FIG. 4(a) is an explanatory sectional view schematically showing a shape of the resin film which is formed on the rotor shaft of the stepping motor in accordance with an embodiment of the present invention. FIG. 4(b) is an explanatory sectional view schematically showing a shape of a resin film on rotor shaft 20′ in a comparison example. FIG. 4(c) is an explanatory sectional view schematically showing a shape of resin film which is formed on the lead screw of the rotor shaft in accordance with an embodiment of the present invention. In accordance with the embodiment of the present invention, a film thickness “w1” of the resin film 202 in a flat face of the base shaft member 201 (flank face 260 and top part 230 of a screw thread) and a film thickness “w2” of the resin film 202 in the edge part 201 are defined as shown in FIGS. 4(a) and 4(c). The film thickness “w2” of the edge part 201a is a film thickness at a position of a bisector to the edge part 201a.

In the stepping motor 1 in the second embodiment, wear of the lead screw 26 can be prevented only by forming the resin film 202 on the lead screw 26 by electrodeposition process. Further, sliding property can be improved by applying a lubricant to the lead screw 26.

Further, in the stepping motor 1 in the second embodiment, the base shaft member 201 of the rotor shaft 20 is made of aluminum or aluminum alloy. Therefore, similar effects to the first embodiment can be attained, for example, the weight of the rotor shaft 20 can be reduced and thus the weight of the stepping motor 1 can be reduced.

Further, in the second embodiment, the base material of the resin film 202 is an epoxy system resin and, when the epoxy system resin is a base material, the resin film 202 can be formed in a smooth face with a high degree of sliding property in comparison with a polyimide system resin and other resin materials.

Especially in the second embodiment, since the resin film 202 contains the fluid adjustment agent and the fluid adjustment auxiliary agent, flowability of the resin film 202 is improved. Therefore, dripping and excessive flowing do not occur in the resin film 202 and thus uniformity of the film formed by electrodeposition coating can be further enhanced. Therefore, as shown in FIGS. 4(a) and 4(c), the film thickness “w1” of the resin film 202 at least on the flank face 260 can be set in an appropriate film thickness (for example, 7 μm or more). Further, in the second embodiment, since the resin film 202 contains the fluid adjustment agent and the fluid adjustment auxiliary agent, flowability of the resin film 202 is suitable. Therefore, the film thickness “w2” of the resin film 202 in the edge part 201a can be set in an appropriate film thickness (for example, 7 μm or more) and thus the edge cover rate ((w2/w1)×100) of the resin film 202 in the edge part 201a can be increased. In other words, according to this second embodiment, the resin film 202 having a film thickness nearly the same as the resin film 202 which is formed on the flank face 260 of the base shaft member 201 is also formed on the edge part 201a. Therefore, a film thickness on the edge part 201a is prevented from being formed to be extremely thin as shown in FIG. 4(b).

As described above, according to this second embodiment, transfer property of material is satisfactory even in a complicated shape and thus the lead screw 26 with a satisfactory dimensional accuracy can be obtained. Further, in the lead screw 26 of the rotor shaft 20 in this second embodiment, the resin film 202 having a sufficient thickness, preferably 7 μm or more, further preferably 10 μm or more, can be formed on the flank face 260 and the edge part 201a. The film thickness of the resin film 202 may be set in 20 μm or less. Even when its film thickness is set to be thicker than this value, its effect is saturated. Further, when the film thickness of the resin film 202 is set to be excessively thick, the shape of the lead screw 26 may be damaged and thus an upper limit value of the film thickness is preferably set in consideration of its groove depth and the like.

A state of applied grease, a worn state of the rack provided in the carrier, and a worn state of the lead screw are evaluated qualitatively after three million (3,000,000) times of seek operation have been performed by the stepping motor 1 in which the rotor shaft 20 in accordance with the second embodiment is used under a temperature condition of 25° C. (degrees Celsius) i.e., at an ordinary temperature. The results are shown in the following Table 1.

TABLE 1

| | Film Thickness of Resin Film | | | | | | | |
|---|---|---|---|---|---|---|---|---|
| | | | | 10 | 12 | | | |
| | 4 μm | 7 μm | 9 μm | μm | μm | 15 μm | 18 μm | 20 μm |
| Grease | X | ◯ | ◯ | ◯ | — | — | ◯ | — |
| Blackening | | | | | | | | |
| Rack Wear | X | ◯ | ◯ | ◯ | — | — | ◯ | — |
| Screw Wear | X | ◯ | ◯ | ◯ | — | — | ◯ | — |

The evaluation in the column of “grease blackening” in the Table 1 is as follows:
Mark “◯”: Blackening change of grease has not occurred.
Mark “x”: Blackening change of grease has remarkably occurred.

The evaluation in the column of “rack wear” in the Table 1 is as follows:
Mark “◯”: Wear in the rack of the carrier 10 is a little, and the tip end part of an engagement part of the carrier 10 has not reached to a bottom part of a groove of the lead screw 26. Blackening change of grease has not occurred.
Mark “x”: Wear of the rack has progressed. The tip end, part of the engagement part of the carrier 10 has reached to the bottom part of the groove of the lead screw 26 and thus the tip end part of the carrier 10 slides on the bottom part of the lead screw 26 to cause the tip end part of the carrier 10 to wear.

The evaluation in the column of “screw wear” in the Table 1 is as follows:
Mark “◯”: Although wear and sliding scratches have occurred in the lead screw 26, wear has not reached to its base metal.
Mark “x”: Wear has progressed in the lead screw 26 to reach to its base metal.

As shown in the Table 1, when the rotor shaft 20 whose film thickness of the resin film 202 is 4 μm is used, blackening change of grease and wear of the rack of the carrier 10 have remarkably occurred and aluminum surface as the base metal has been exposed on the almost entire surface of a sliding face of the lead screw 26. On the other hand, when the rotor shaft 20 whose film thickness of the resin film 202 is 7 μm or more (7 μm, 9 μm, 10 μm or 18 μm) is used, blackening change of grease has not occurred and wear in the rack of the carrier 10 is a little and, in addition, aluminum surface has not been exposed in the sliding face of the lead screw 26.

According to the above-mentioned results, the rotor shaft 20 having a superior reliability can be structured by setting the film thickness of the resin film 202 in 7 μm or more.

A state of applied grease, a worn state of the rack provided in the carrier, and a worn state of the lead screw 26 are evaluated qualitatively after three million (3,000,000) times of seek operation have been performed under a temperature condition of 70° C. (degrees Celsius) in cases that the film thicknesses of the resin film 202 which is formed on the rotor shaft 20 of the stepping motor 1 are respectively set in 7 μm, 12 μm and 20 μm. As a result, in the case of the rotor shaft 20 whose film thickness of the resin film 202 is set in 7 μm, blackening change of grease and wear of the rack of the carrier have been remarkably occurred and aluminum surface of the lead screw 26 has been exposed. On the other hand, in the cases of the rotor shaft 20 whose film thicknesses of the resin film 202 are set in 12 μm and 20 μm, blackening change of grease has not occurred and wear of the rack of the carrier 10 is a little. As described above, when the film thickness of the resin film 202 is set in 10 μm or more, the resin film 202 is capable of coping with a high temperature condition.

A state of applied grease, a worn state of the rack provided in the carrier 10, and a worn state of the lead screw 26 are evaluated qualitatively after three million (3,000,000) times of seek operation have been performed under a temperature condition of −5° C. (minus 5 degrees Celsius) in cases that the film thicknesses of the resin film 202 which is formed on the rotor shaft 20 of the stepping motor 1 are respectively set in 10 μm and 15 μm. As a result, in both the cases of the rotor shaft 20 whose film thicknesses of the resin film 202 are set in 10 μm and 15 μm, blackening change of grease has not occurred and wear in the rack of the carrier 10 is a little and, in addition, aluminum surface has not been exposed in the sliding face of the lead screw 26. As described above, when the film thickness of the resin film 202 is set in 10 μm or more, the resin film 202 is also capable of coping with a low temperature condition.

In cases that the film thicknesses of the resin film 202 which is formed on the rotor shaft 20 of the stepping motor 1 are respectively set in 10 μm and 15 μm, a state of applied grease, a worn state of the rack provided in the carrier 10, and a worn state of the lead screw 26 are evaluated qualitatively after three million (3,000,000) times of seek operation have been performed under a condition that the temperature is 40° C. and humidity is 90% RH. As a result, in both the cases of the rotor shaft 20 whose film thicknesses of the resin film 202 are set in 10 μm and 15 μm, blackening change of grease has not occurred and wear in the rack of the carrier 10 is a little and, in addition, aluminum surface has not been exposed in the sliding face of the lead screw 26. As described above, when the film thickness of the resin film 202 is set in 10 μm or more, the resin film 202 is also capable of coping with a high humidity condition.

### Third Embodiment

A basic structure of a third embodiment of the present invention is similar to those of the first and the second embodiments and thus the description of the common portions is omitted. In the third embodiment, the base shaft member 201 of the rotor shaft 20 in the stepping motor 1 is made of steel material except stainless steel. Therefore, the rotor shaft 20 can be manufactured at a low cost in comparison with a case that the rotor shaft 20 is manufactured by using stainless steel or brass and thus the stepping motor 1 can be manufactured at a low cost.

Further, when a lead screw is formed by using a base shaft member 201 made of steel material except stainless steel as it is, the lead screw is provided with a high corrosiveness. However, corrosion resistance of the lead screw can be improved by forming the resin film 202 or by forming a composite film which is formed by applying thermal oxidation film treatment and then forming a resin film.

In accordance with an embodiment, when stainless steel is used as the base shaft member 201 of the rotor shaft 20, in a case that the resin film 202 is formed only on a prescribed portion of the rotor shaft 20, a portion of the rotor shaft 20 without the resin film 202 is also provided with a sufficient corrosive resistance.

### Another Embodiments

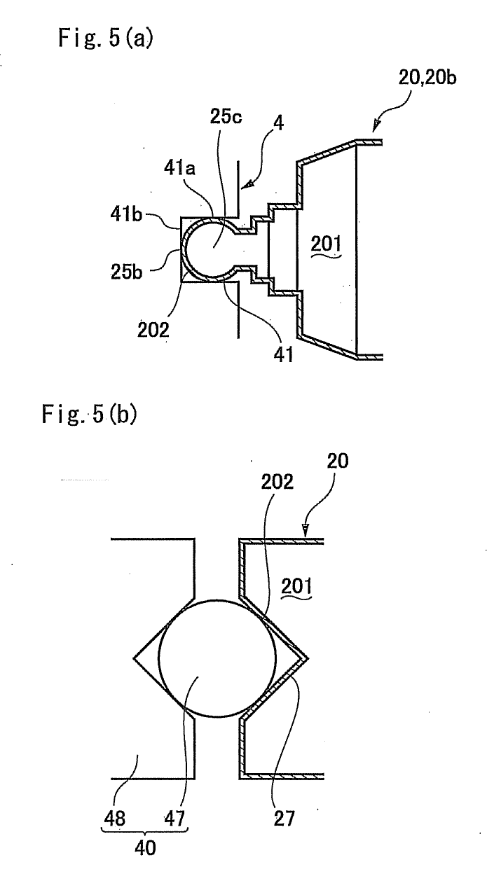

FIGS. 5(a) and 5(b) are explanatory views showing another bearing structures which are used in a motor in accordance with an embodiment of the present invention. In the embodiments described above, the round bar-shaped protruded part 25 is formed in the output side shaft end 20b of the rotor shaft 20. However, as shown in FIG. 5(a), a spherical protruded part 25c may be formed in the output side shaft end 20b of the rotor shaft 20. In this case, a surface of the spherical protruded part 25c is covered with a resin film 202 which is an electrodeposited film. Further, as shown in FIG. 5(b), it may be structured that a conical recessed part 27 is formed at an end face of the output side or the opposite-to-output side of the rotor shaft 20 and the conical recessed part 27 is supported by a bearing 40 provided with a steel ball 47 and a holder 48. In this case, a resin film 202 which is an electrodeposited film is formed on at least an inner face of the conical recessed part 27.

Further, in the embodiments described above, electrodeposition is performed directly on the surface of the base shaft member 201 to form the resin film 202. However, in the first and second embodiments in which the base shaft member 201 of the rotor shaft 20 is made of aluminum or aluminum alloy, it may be structured such that an underlying film such as a chromate film or an alumite film is formed on the surface of the base shaft member 201 and, after that, electrodeposition is performed on the surface to form the resin film 202. Since an alumite film formed as the underlying film is hard, wear of the rotor shaft 20 can be prevented even when the resin film 202 is chipped.

Further, in the third embodiment in which the base shaft member 201 of the rotor shaft 20 is made of steel material, the resin film 202 may be formed such that an underlying film (chemical conversion film) such as a phosphate film (tribasic zinc phosphate film, manganese phosphate film, iron phosphate film and the like) is formed on the surface of the base shaft member 201 and, after that, electrodeposition is performed on the surface to form the resin film 202. Since an phosphate film formed as the underlying film is dense and porous, adhesive strength between the resin film 202 and the base shaft member 201 is improved by anchoring effect and thus the resin film 202 is prevented from peeling off from the base shaft member 201.

Further, in the embodiment described above, the resin film 202 is formed on the nearly entire face of the rotor shaft 20. However, the resin film 202 may be formed on only the sliding portion on the bearing and the lead screw 26 and, alternatively, the resin film 202 may be formed on only the lead screw 26. Further, the resin film 202 may be formed only on the flank face 260 of the lead screw 26. Further, in the embodiment described above, the resin film 202 is formed on the sliding portions on the bearings at both shaft ends of the rotor shaft 20. However, the present invention is not limited to this embodiment. The resin film 202 may be formed only one of the sliding portions of the shaft ends on the bearings. In addition, the present invention may be applied to a case where a bearing is used, which supports the rotor shaft 20 only in a radial direction, or a case where a bearing is used, which supports the rotor shaft 20 only in a thrust direction.

In the embodiments described above, the permanent magnets 28 and 29 are fixed to the rotor shaft 20. In a case that the permanent magnets 28 and 29 are easily fixed to the rotor shaft 20 by providing the resin film 202 on the rotor shaft 20, the resin film 202 may be preferably formed on the surface of the rotor shaft 20 to which the permanent magnets 28 and 29 are fixed. On the contrary, when a fixing method is adopted in which the permanent magnets 28 and 29 are easily fixed to the rotor shaft 20 without the resin film 202, the resin film 202 may be formed on the surface of the rotor shaft 20 except a portion where the permanent magnets 28 and 29 are fixed.

In addition, in the embodiments described above, polyimide system resin and epoxy system resin are used as the base material of the resin film 202. However, resin material having a composite composition comprising of polyimide system resin and epoxy system resin. For example, resin material having a structure in which a cation sensitive group is introduced in a polymer having imide bonding may be used. Further, a resin component as a binder may be added in the resin material.

In the embodiments described above, the present invention is applied to a case that the base shaft member 201 of the rotor shaft 20 is made of aluminum or aluminum alloy. However, the present invention may be applied to a case that the base shaft member of the rotor shaft 20 is made of stainless steel or brass.

Further, in the embodiments described above, the resin film 202 is formed by electrodeposition coating. However, the present invention is not limited to the embodiments and powder coating and spray coating may be used as a coating method.

In addition, in the embodiments described above, the present invention is applied to a stepping motor. However, the present invention may be applied to any motor that is provided with a rotor having a rotor shaft and a bearing which rotatably supports the rotor shaft.

Further, in the embodiments described above, the present invention is applied to a rotor shaft which is used in a motor. However, the present invention may be applied to a rotor shaft to which an output from a motor is transmitted through a gear mechanism.

Further, according to a forming method of coating film by electrodeposition, a film can be uniformly formed and thus this forming method may be applied to all the resin materials described in the above-mentioned embodiments.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotor shaft comprising:
a base shaft member for structuring the rotor shaft;
a lead screw which is formed on an outer peripheral face of the base shaft member; and
a resin film which covers the lead screw.

2. The rotor shaft according to claim 1, wherein the resin film is an electrodeposited film.

3. The rotor shaft according to claim 1, wherein a film thickness of the resin film on at least a flank face of the lead screw is 7 μm or more.

4. The rotor shaft according to claim 1, wherein the resin film is a polyimide system resin film.

5. The rotor shaft according to claim 1, wherein the resin film contains epoxy system resin having epoxy group as a thermal reactive group.

6. The rotor shaft according to claim 1, wherein the resin film contains solid lubricant.

7. The rotor shaft according to claim 6, wherein the solid lubricant is at least one of polytetrafluoroethylene (PTFE) particles and graphite particles.

8. The rotor shaft according to claim 1, wherein the resin film contains filler.

9. The rotor shaft according to claim 8, wherein the filler is a fluid adjustment agent for improving flowability of resin.

10. The rotor shaft according to claim 9, wherein the fluid adjustment agent is acrylic-melamine system resin.

11. The rotor shaft according to claim 8, wherein the filler is organic system filler.

12. The rotor shaft according to claim 1, wherein the base shaft member is made of aluminum or aluminum alloy.

13. The rotor shaft according to claim 12, wherein an alumite film is formed between the base shaft member and the resin film.

14. The rotor shaft according to claim 1, wherein the base shaft member is made of iron or iron alloy.

15. The rotor shaft according to claim 14, wherein a chemical conversion film is formed between the base shaft member and the resin film.

16. A motor comprising:
a rotor shaft which is formed with a lead screw on a peripheral face of the rotor shaft;
a rotor which is provided with the rotor shaft;
a bearing which rotatably supports the rotor shaft; and
a stator which faces the rotor;
wherein a flank face of the lead screw for moving a carrier which is to be engaged with the lead screw is coated with a resin film.

17. The motor according to claim 16, wherein the resin film is an electrodeposited film.

18. The motor according to claim 16, wherein a film thickness of the resin film on at least the flank face of the lead screw is 7 μm or more.

19. The motor according to claim 16, wherein the resin film is a polyimide system resin film.

20. The motor according to claim 16, wherein the resin film contains epoxy system resin having epoxy group as a thermal reactive group,

21. The motor according to claim 16, wherein the resin film contains solid lubricant.

22. The motor according to claim 16, wherein the resin film contains filler.

23. The motor according to claim 16, wherein the lead screw is made of aluminum or aluminum alloy.

24. The motor according to claim 23, further comprising an alumite film which is formed on an under side of the resin film in the lead screw.

25. The motor according to claim 16, wherein the lead screw is made of iron or iron alloy.

26. The motor according to claim 25, further comprising a chemical conversion film which is formed on an under side of the resin film in the lead screw.

27. A motor comprising:
a rotor shaft;
a rotor which is provided with the rotor shaft; and
a bearing which rotatably supports the rotor shaft;
wherein at least a sliding portion of the rotor shaft on the bearing is covered with a resin film.

28. The motor according to claim 27, wherein the resin film is an electrodeposited film.

29. The motor according to claim 27, wherein the resin film is a polyimide system resin film.

30. The motor according to claim 27, wherein the resin film contains epoxy system resin having epoxy group as a thermal reactive group.

31. The motor according to claim 27, wherein the resin film contains solid lubricant.

32. The motor according to claim 31, wherein the solid lubricant is at least one of polytetrafluoroethylene (PTFE) particles and graphite particles.

33. The motor according to claim 27, wherein the resin film contains filler.

34. The motor according to claim 33, wherein the filler is a fluid adjustment agent for improving flowability of resin.

35. The motor according to claim 34, wherein the fluid adjustment agent is acrylic-melamine system resin.

36. The motor according to claim 33, wherein the filler is organic system filler.

37. The motor according to claim 27, wherein a base shaft member of the rotor shaft is made of aluminum or aluminum alloy.

38. The motor according to claim 37, wherein an alumite film is formed between the base shaft member and the resin film.

39. The motor according to claim 37, wherein the rotor shaft is formed with a spherical part which is supported by the bearing.

40. The motor according to claim 27, wherein a base shaft member of the rotor shaft is made of iron or iron alloy.

41. The motor according to claim 40, wherein a chemical conversion film is formed between the base shaft member and the resin film.

42. The motor according to claim 40, wherein the rotor shaft is formed with a spherical part which is supported by the bearing.

43. The motor according to claim 27, further comprising a lead screw which is formed on an outer peripheral face of the base shaft member;
wherein the lead screw is covered with a resin film which is an electrodeposited film.
